(19) United States
(12) Patent Application Publication
(10) Pub. No.: US 2024/0406607 A1
(43) Pub. Date: Dec. 5, 2024

(54) MICROPHONE STAND AND RECORDING STRUCTURE

(71) Applicant: TILTA INC., Burbank, CA (US)

(72) Inventors: Yaolong Luo, Shenzhen (CN); Wenping Zeng, Shenzhen (CN); Kefeng Zhou, Shenzhen (CN); Jared Cohn, Los Angeles, CA (US)

(21) Appl. No.: 18/227,715

(22) Filed: Jul. 28, 2023

(30) Foreign Application Priority Data
Jun. 1, 2023 (CN) 202310643225.8

(51) Int. Cl. H04R 1/08; F16M 11/04; F16M 11/20; G06F 3/16; H04R 1/32

(52) U.S. Cl. CPC H04R 1/08; F16M 11/041; F16M 11/2064; G06F 3/162; H04R 1/326; F16M 11/2092; F16M 11/28; F16M 13/04; F16M 2200/044

(57) ABSTRACT

A microphone stand comprises a support rod and a support component for supporting the support rod, wherein the support rod is provided with a mounting position for mounting a microphone, and the support component is movably connected to the support rod. The support rod is provided with an adjustment system at an end of the support rod away from the support component to adjust the pitch angle of the support component. The adjustment system and the support component greatly reduce the workload of the operator and potential injury of the operator.

### CROSS-REFERENCE TO RELATED APPLICATIONS

The present Application for Patent claims priority to and the benefit of pending Chinese Utility Model application No. 202310643225.8, filed Jun. 1, 2023, and hereby expressly incorporated by reference herein as if fully set forth below in its entirety and for all applicable purposes.

### TECHNICAL FIELD

The present disclosure relates to the field of microphone equipment, in particular to a microphone stand and recording structure.

### INTRODUCTION

A microphone is a device often used in shooting films and videos. Currently, a common way of sound collection uses a microphone connected to one end of a support rod, and the operator holds the other end of the support rod with both hands to adjust the pitch angle of the support rod to bring the microphone close to (or away from) the person to be photographed or filmed. The operator's arm can get tired and become sore when shooting for a long time.

As disclosed in the related art, a microphone for radio and television comprises a support rod (e.g., Chinese Application No. CN201821297949.2). A telescopic rod is movably connected to one end of the support rod, one end of the telescopic rod is inserted inside the support rod, a rotating connection port is movably connected to one end of the telescopic rod away from the support rod, a connecting shaft is fixedly connected inside the rotating connection port. The outer surface of the connecting shaft is sleeved with a movable rod fixation clamp, and the front of the movable rod fixation clamp is provided with screws. The microphone of the prior mentioned above has various shortcomings.

### BRIEF SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a form as a prelude to the more detailed description that is presented later.

To solve the above problems, the present disclosure aims to provide a microphone stand, which makes it easier for operators to use the stand; and it is more convenient to operate when adjusting the angle of the microphone.

Another object of the present disclosure is to provide a recording structure that is easier to use, and it is more convenient to operate when adjusting the angle of the microphone.

In order to achieve the above object, the technical schemes of the present disclosure are as follows.

A microphone stand includes a support rod and a support component for supporting the support rod. The support rod is provided with a mounting position for mounting a microphone, and the support component is movably connected to the support rod. The support rod is provided with an adjustment system at one end of the support rod away from the mounting position of the support component to adjust the pitch angle of the support component.

A recording structure comprises a microphone, a recording device, and a microphone stand. The support rod is supported by a support component, and the joint between the two can be rotated; When in use, the height of the microphone can be adjusted by moving the adjustment system to adjust the pitch angle of the support rod.

The beneficial effects of the present disclosure are that in the present disclosure, with the support of the support component, when an operator operates the microphone stand, one hand can move freely, and only the other hand needs to vertically move the adjustment system to adjust the pitch angle of the support rod, thereby adjusting the height of the microphone. In the present disclosure, there is no need to lift the support rod by hand, which greatly reduces the workload of the operator and avoids soreness in their hands.

### BRIEF DESCRIPTION OF THE DRAWINGS

In order to more clearly illustrate the embodiments of the present disclosure or the technical schemes in the prior art, the drawings used in the description of exemplary embodiments will be briefly introduced below. Obviously, the drawings in the following description are only examples of the present disclosure. For those ordinarily skilled in the art, other implementations can be obtained according to the structures shown in these drawings.

FIG. 1 is a schematic diagram of a microphone stand according to some aspects of the present disclosure.

FIG. 2 is a schematic diagram illustrating an enlarged view of area A in FIG. 1.

FIG. 3 is a schematic diagram illustrating the connection between a support rod, an adjusting rod, and a transmission mechanism according to some aspects of the disclosure.

FIG. 4 is a schematic diagram of a transmission mechanism, a first connecting assembly, and a turnplate of a transmission rope according to some aspects of the disclosure.

FIG. 5 is a schematic diagram of the transmission mechanism, the first connecting assembly, and the turnplate of FIG. 4 from a different perspective according to some aspects of the disclosure.

FIG. 6 is a schematic diagram of an exemplary connecting piece and a washer.

FIG. 7 is a schematic diagram of a support component according to some aspects of the disclosure.

FIG. 8 is a schematic diagram of the microphone stand of FIG. 1 from a second perspective.

FIG. 9 is an enlarged view of area B in FIG. 8.

FIG. 10 is an enlarged view of area C in FIG. 8.

FIG. 11 is a perspective view of a microphone mounting assembly according to some aspects of the disclosure.

### REFERENCE NUMERALS

1-support rod;
11-second annular chute;
12-second connecting piece;
121-second clamping part;
122-second strip groove;
13-second locking piece;
131-second clamping ring;
132-second clamping opening;
133-second clamping wrench;
14-washer;
2-adjustment system;
21-adjusting rod;
211-turnplate;
212-first annular chute;
22-transmission mechanism;
221-first connecting part;
222-second connecting part;
223-angle;
224-drive rope;
2241-first rope part;
2242-second rope part;
225-pulley;
3-support component;
31-support member;
32-support ring;
33-triangular fork;
34-telescopic rod;
4-first connecting piece;
41-first clamping part;
42-first strip groove;
5-first locking member;
51-first clamping ring;
52-first clamping opening;
53-first clamping wrench;
6-microphone mounting assembly;
61-mounting bracket;
62-regulating bracket;
621-strip chute;
622-slider;
63-support clip;
64-screw;
7-counterweight bracket;
71-avoidance cavity;
72-counterweight weight;
73-locking ring; and
8-microphone.

### DETAILED DESCRIPTION

In order to make the object, technical schemes, and advantages of the present disclosure clearer, the present disclosure will be further described in detail with reference to the accompanying drawings and embodiments. It should be understood that the specific embodiments described here are intended for illustrating the present disclosure, but not for limiting the present disclosure.

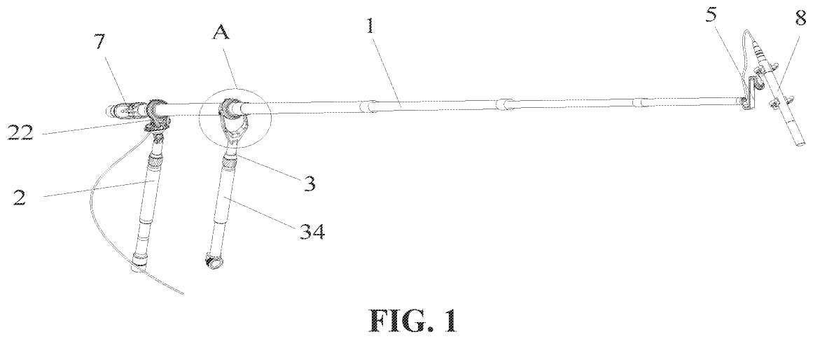

Referring to FIG. 1, an exemplary embodiment provides a microphone stand. The microphone stand comprises a support rod 1 and a support component 3 for supporting the support rod 1. The support rod 1 is provided with a mounting position for mounting a microphone 8, which can be an existing structure for mounting the microphone 8. One end of the support component 3 is movably connected with the support rod 1 to support it, and the support rod 1 can move (e.g., pitch or pivot) relative to the support component 3. One end of the support rod 1 away from the mounting position of the support component 3 is provided with an adjustment system 2, and the adjustment system 2 is provided with a handheld position for handheld use, which is the position held by the user's hand.

In some examples, the support component 3 can be mounted on the ground, on a vehicle, or on an operator, and the operator holds the adjustment system 2 by hand. By moving the adjustment system 2, the support rod 1 rotates along the vertical plane relative to the support component 3 to achieve the pitch movement of the support rod 1. Such that the angle and/or position of the support rod 1 can be adjusted, to ensure that the microphone 8 can continuously collect sound from the desired source or position. In this embodiment, with this arrangement, the operator can hold and maneuver the adjustment system 2 with one hand while adjusting the support rod 1. With the adjustment system 2, the operator does not need to hold the support rod 1 with both hands extending high up in order to adjust the pitch of the support rod 1, thus achieving painless and easy operation during the recording process and potentially freeing up at least one of the operator's hands.

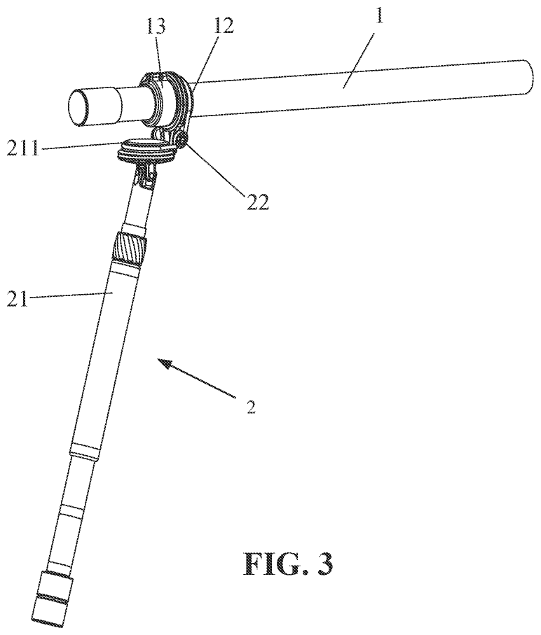

Referring to FIG. 3, the adjustment system 2 in an embodiment comprises an adjusting rod 21 and a transmission mechanism 22, wherein one end of the transmission mechanism 22 is movably connected to the adjusting rod 21, and the other end is in transmission connection with the support rod 1, so that when the adjusting rod 21 rotates around its axis, the support rod 1 is driven to rotate around its axis by the transmission mechanism 22.

In some aspects, the support component 3 can be fixed or secured on the ground or at other structural positions/locations to support the support rod 1. At the same time, because the support component 3 is movably connected with the support rod 1, the support component 3 does not hinder the rotation of the support rod 1 when it is supported by the support component 3. When the operator operates the microphone stand, one hand can move freely, and only the other hand needs to hold the adjusting rod 21. There is no need to lift the support rod 1 directly by hand, thus greatly reducing the operator's workload and avoiding soreness and fatigue in their hands.

When the angle or position of the support rod 1 needs to be adjusted, the operator can rotate the adjusting rod 21 by hand. When the adjusting rod 21 rotates, it drives the transmission mechanism 22 to rotate the support rod 1 around its axis, achieving control of the angle and position of the microphone 8 mounted on the support rod 1. The microphone stand illustrated in the drawings enables adjustment of the directions of the microphone 8 while reducing injury to the wrist of the operator.

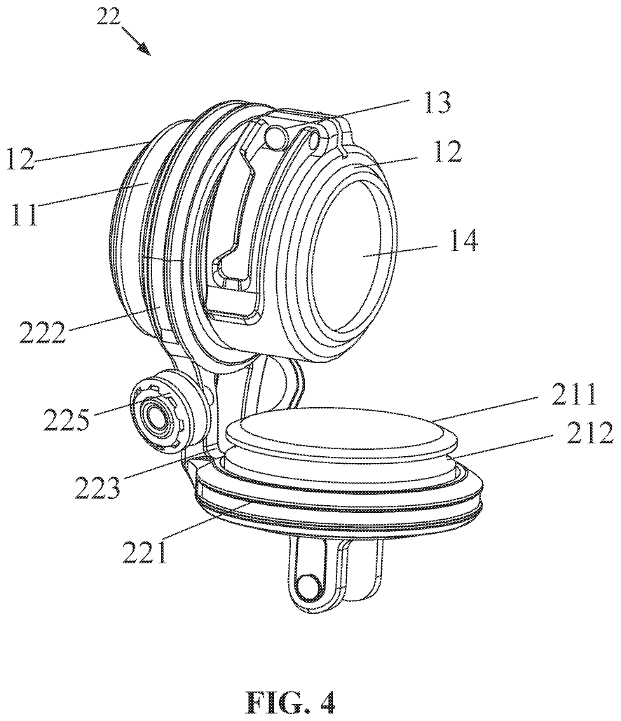

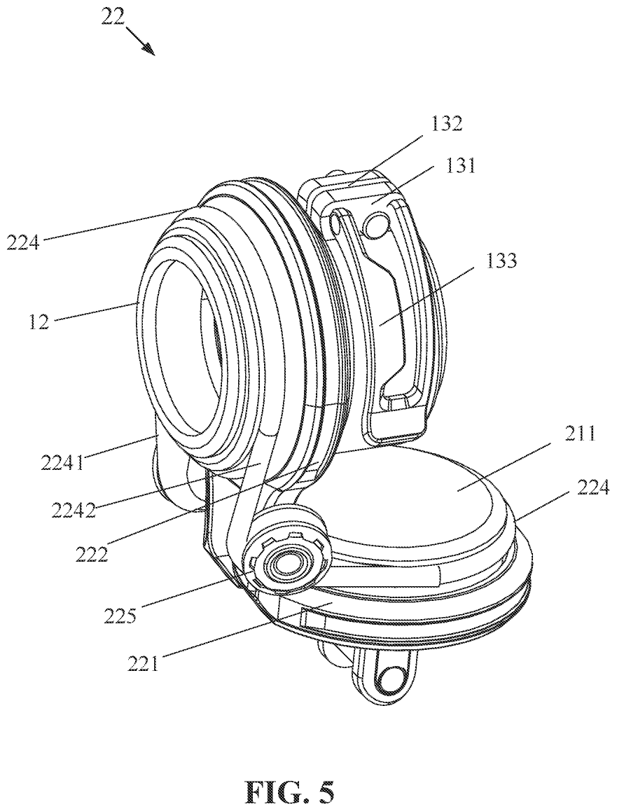

Referring to FIGS. 4-5, the transmission mechanism 22 in an embodiment comprises a transmission frame body and a transmission assembly. The transmission frame body comprises a first connecting part 221 and a second connecting part 222. The first connecting part 221 is connected with the second connecting part 222, and an angle 223 is formed at the joint between the first connecting part 221 and the second connecting part 222. The first connecting part 221 can be movably connected with the adjusting rod 21. The second connecting part 222 can be movably connected with the support rod 1, and the adjusting rod 21 is in transmission connection with the support rod 1 via the transmission mechanism 22.

In this embodiment, both the first connecting part 221 and the second connecting part 222 have annular structures. The first connecting part 221 is rotatably sleeved on the adjusting rod 21, and the second connecting part 222 is rotatably sleeved on the support rod 1.

In this embodiment, the angle 223 can be a right angle. When the angle 223 is set at a right angle, the adjusting rod 21 is set in a vertical state relative to the support rod 1 when the support rod 1 is horizontally placed during use, making the adjustment of the adjusting rod 21 more convenient.

Referring to FIG. 5, the transmission assembly in an embodiment comprises a transmission rope 224 and a plurality of pulleys 225, wherein the pulleys 225 are movably arranged on both sides of the first connecting part 221 or the second connecting part 222 respectively. The two ends of the transmission rope are sleeved on the support rod 1 and the adjusting rod 21 respectively, and two sides of the middle part of the transmission rope 224 are sleeved on a plurality of pulleys respectively. The plurality of pulleys 225 play a role in guiding the transmission rope 224, while allowing for rotation without obstructing the transmission of the transmission rope 224. Specifically, when the adjusting rod 21 rotates, it will drive one end of the transmission rope 224 sleeved on it to move, and then the other end of the transmission rope 224 will synchronously drive the support rod 1 to rotate, so as to realize the rotation of the horizontal plane of the adjusting rod 21, which is transformed into the rotation of the support rod 1 along its axis. So that the direction or angle of the microphone 8 can be adjusted along with the rotation of the support rod 1. With this arrangement, the process of direction adjustment of the microphone 8 becomes simpler and faster, which helps to improve the efficiency of sound collection using microphone stand illustrated in the drawings.

Referring to FIG. 5, the two ends of the transmission rope 224 are sleeved on the support rod 1 and the adjusting rod 21 respectively. Specifically, the transmission rope 224 includes a first rope part 2241 and a second rope part 2242. A first end of the first rope part 2241 is fixed to a first end of the second rope part 2242, and a second end of the first rope part 2241 and a second end of the second rope part 2242 are sleeved on the adjusting rod 21. The second end of the first rope part 2241 is fixed to the second end of the second rope part 2242, and the first end of the first rope part 2241 and the first end of the second rope part 2242 are fixedly sleeved on the support rod 1. The middle part of the first rope part 2241 and the middle part of the second rope part 2242 respectively pass through a plurality of pulleys 225 for abutting the rope parts against the pulleys.

Referring to FIGS. 4-5, the adjusting rod 21 in an embodiment is provided with a first annular chute 212, and the support rod 1 is provided with a second annular chute 11; One end of the transmission rope 224 is sleeved inside the first annular chute 212, and can be wound multiple times inside the first annular chute 212. The other end of the transmission rope 224 is sleeved inside the second annular chute 11, and can be wound multiple times inside the second annular chute 11. The arrangement of the first annular chute 212 and the second annular chute 11 enhances the connection stability between the transmission rope 224, the adjusting rod 21, and the support rod 1. One end of the transmission rope 224 can be wound multiple times in the first annular chute 212, while the other end of the transmission rope 224 is wound multiple times in the second annular chute 11 to enhance the reliability of the transmission rope 224 during transmission.

Referring to FIGS. 4-5, the upper end of the adjusting rod 21 in an embodiment is provided with a turnplate 211, and the turnplate 211 is movably connected with the upper end of the adjusting rod 21 through a universal joint. The first connecting part 221 is rotatably sleeved on the outside of the turnplate 211. One end of the first rope part 2241 and one end of the second rope part 2242 are fixedly sleeved on the turnplate 211. In some aspects, a bearing may be provided between the first connecting part 221 and the turnplate 211. The first annular chute 212 is arranged on the outer surface of the turnplate 211 and above the connection between the first connecting part 221 and the turnplate 211. One end of the first rope part 2241 and one end of the second rope part 2242 are sleeved on the first annular chute 212. The arrangement of the universal joint can be used to control the relative angle between the adjusting rod 21 and the support rod 1, which can facilitate the use and control of the adjusting rod 21. When in use, the angle (e.g., a tilt angle) between the adjusting rod 21 relative to the support rod 1 can be adjusted.

Referring to FIGS. 4-6, the microphone stand in an embodiment further comprises a connecting assembly. The connecting assembly comprises a second connecting piece 12 and a second locking piece 13. The second connecting piece 12 can be movably sleeved on the support rod 1. The second locking piece 13 is connected with the second connecting piece 12, to control the second connecting piece 12 to be locked on the support rod 1. A second connecting part 222 is rotatably sleeved on the outside of the second connecting piece 12, and the other end of the first rope part 2241 and the other end of the second rope part 2242 are fixedly sleeved on the second connecting piece 12. In some aspects, a bearing may be provided between the second connecting part 222 and the second connecting piece 12. The second annular chute 11 is arranged on the outer surface of the second connecting piece 12, with one end of the first rope part 2241 and the other end of the second rope part 2242 fixedly sleeved on the second annular chute 212. The connection between the second connecting part 222 and the second connecting piece 12 can be arranged between the second annular chute 11 and the second locking piece 13, so that the second connecting piece 12 can rotate more evenly relative to the second connecting part 222. In some aspects, the second connecting piece 12 can be locked by the second locking piece 13 to achieve locking and fixation on the support rod 1. By controlling the rotation of the adjusting rod 21, the adjusting rod 21 can drive the second connecting piece 12 to rotate through the transmission rope 224. Then the second connecting piece 12 drives the support rod 1 to rotate, realizing the conversion of the vertical rotation of the adjusting rod 21 into the horizontal rotation of the support rod 1, thereby saving the physical strength of the operator and promoting more relaxed and smooth sound collection.

In one embodiment, one end of the second connecting piece 12 is provided with a second clamping part 121, and the second clamping part 121 is provided with a plurality of second strip grooves 122, which allows deformation of the second clamping part 121. The second strip groove 122 runs through the inner and outer surfaces of the second clamping part 121 and the other end of the second clamping part 121. The second locking piece 13 comprises a second clamping ring 131, which is provided with a second clamping opening 132, and a second clamping wrench 133 for adjusting the opening and closing degree of the second clamping opening 132. The second clamping ring 131 is sleeved on the second clamping part 121 to control the second clamping part 121 to be clamped or tightened on the support rod 1. The degree of opening and closing degree of the second clamping opening 132 is adjusted by the movable second clamping wrench 133 to achieve control of whether the second clamping ring 131 is clamped on the second clamping part 121. The second strip groove 122 is provided to enable the other end of the second clamping section 121 to be deformed while being clamped by the second clamping ring 131 to clamp and lock on the support rod 1.

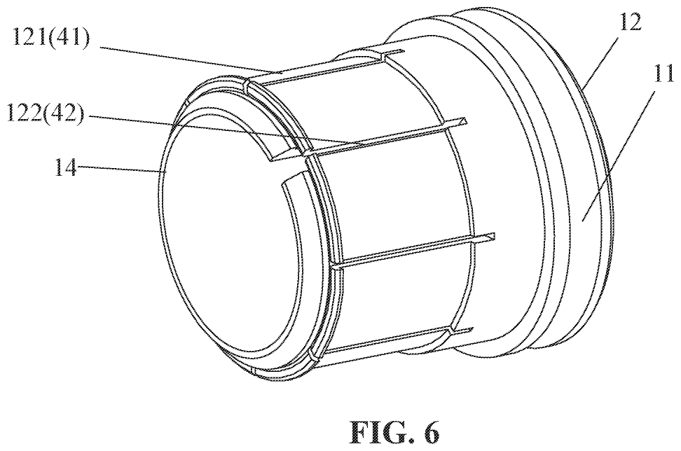

Referring to FIG. 6, a washer 14 in an embodiment is sleeved on the support rod 1 corresponding to the second clamping part 121, and the second clamping part 121 is sleeved outside for abutting against the washer 14. The arrangement of the washer 14 can not only avoid the wear between the second connecting piece 12 and the support rod 1, but also increase the friction between the support rod 1 and the second connecting piece 12, so that when the second connecting piece 12 rotates, it can stably drive the support rod 1 to rotate. In some aspects, the washer 14 can be an open washer 14 for adapting to different sizes of support rod 1. Washer 14 with different sizes can also be arranged to adapt to the support rod 1 with different diameters.

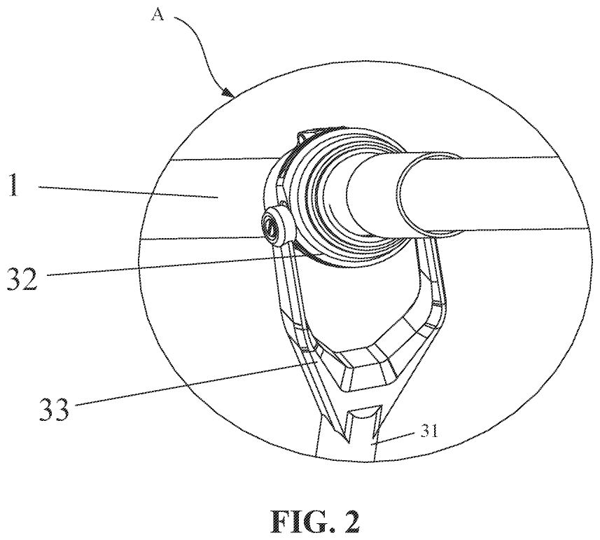

Referring to FIGS. 1, 2, and 7, the support component 3 in an embodiment comprises a support member 3 and a support ring 32, the support rod 1 can be rotatably arranged in the support ring 32, and the support member 3 is movably connected with the support ring 32. In this embodiment, the support rod 1 can rotate relative to the support ring 32 to adjust the direction of the microphone 8 to facilitate the sound collection process. The support rod 1 can also be pitched relative to the support rod 3 to adjust the height of the microphone 8, facilitating the sound collection process.

In some aspects, the support member 31 and the support ring 32 can be directly or indirectly movably connected. In the case of indirect movable connection, a triangular fork 33 is fixed at one end of the support member 31, and the other two ends of the triangular fork 33 are hinged with two opposite sides of the support ring 32, and the other end of the triangular fork 33 is connected with the support member 31. The arrangement of the triangular fork 33 makes the support of the support member 31 to the support rod 1 more stable, and reduces the possibility of the support rod 1 shifting relative to the support member 31 during the pitch movement of the support rod 1 relative to the support member 31.

In one embodiment, the other end of the support component 3 is a telescopic rod 34. In some aspects, the support member 31 can be a telescopic rod 34, which comprises a plurality of sleeved rod bodies. When any two rod bodies are rotated, the support component 3 can be extended or contracted. Due to the arrangement of the telescopic rod 34, the support component 3 can be extended and contracted according to the needs, making it more convenient to use.

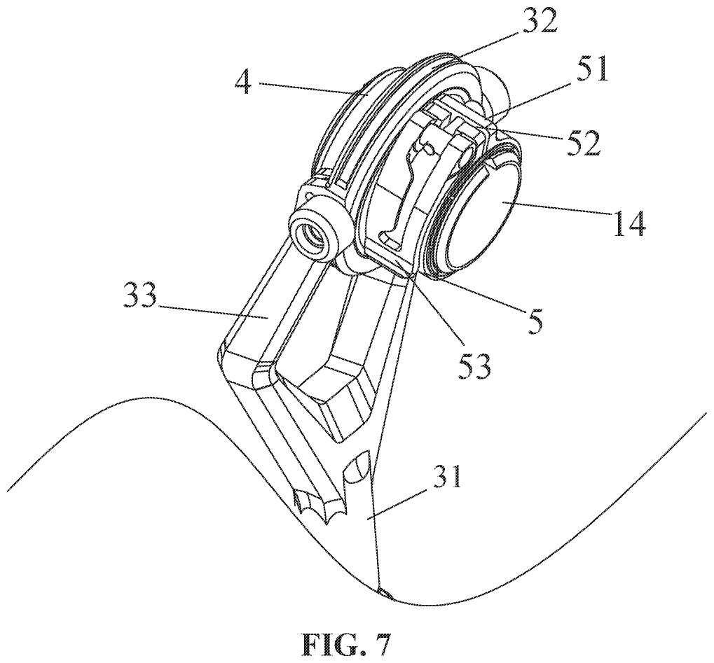

Referring to FIG. 7, the microphone stand in one embodiment further comprises a first connecting piece 4 and a first locking piece 5, wherein the first connecting piece 4 is sleeved on a support rod 1, the first locking piece 5 is sleeved on the first connecting piece 4 to lock or secure the first connecting piece 4 on the support rod 1, and the support ring 32 is rotatably sleeved on the first connecting piece 4. In this way, when the adjustment system 2 drives the first connecting piece 4 to rotate, the first connecting piece 4 drives the support rod 1 to rotate around the axis relative to the support ring 32, and the support ring 32 is not affected by the rotation of the support rod 1, thus ensuring the stable support function of the support component 3. In some aspects, a bearing may be provided between the support ring 32 and the first connecting piece 4, to ensure that the support ring 32 remains stationary when the first connecting piece 4 and the support rod 1 rotate.

In one embodiment, the first connecting piece 4 can be similar to the second connecting piece 12 illustrated in FIG. 6. One end of the first connecting piece 4 is provided with a first clamping part 41. The first clamping part 41 is provided with a plurality of first strip grooves 42, which enable the first clamping part 41 to have a certain deformation. The first strip groove 42 can run through the inner and outer surfaces of the first clamping part 41 and one end of the first clamping part 41.

Referring to FIG. 7, the first locking piece 5 comprises a first clamping ring 51, which is provided with a first clamping opening 52. The first clamping ring 51 is movably provided with a first clamping wrench 53 for adjusting the opening and closing degree of the clamping opening 52. The first clamping ring 51 is sleeved on the first clamping part 41 to control the first clamping part 41 to be clamped on the support rod 1. By moving the first clamping wrench 53, the degree of opening and closing of the first clamping opening 52 can be adjusted, to control whether the first clamping ring 51 is clamped on the first clamping part 41. Moreover, through the arrangement of the first strip groove 42, the other end of the first clamping part 41 can be deformed when clamped by the first clamping ring 51, so as to be clamped and locked on the support rod 1.

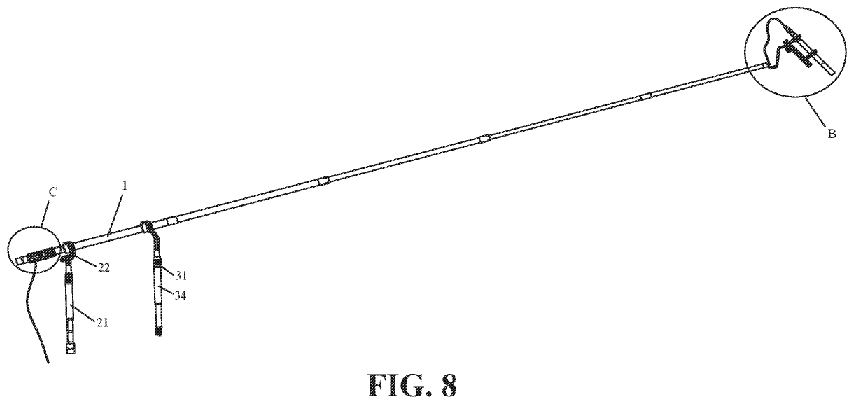

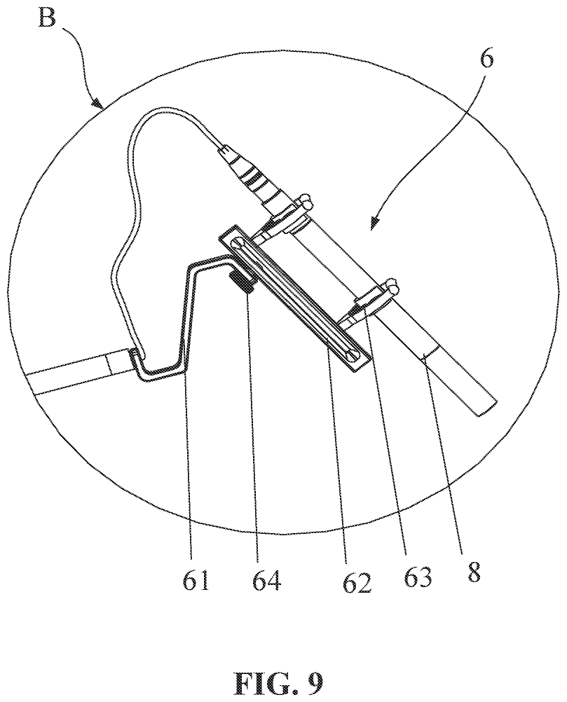

Referring to FIGS. 8 and 9, a microphone mounting assembly 6 in one embodiment is fixedly arranged at one end of the support rod 1, and the mounting position is arranged on the microphone mounting assembly 6.

Referring to FIG. 9, the microphone mounting assembly 6 in one embodiment comprises a mounting bracket 61 and an adjusting bracket 62. One end of the mounting bracket 61 is fixed to the support rod 1, and the other end is movably (e.g., slidingly) connected to the adjusting bracket 62, and a mounting position is arranged on the side of the adjusting bracket 62 away from the mounting bracket 61. In one embodiment, when the support rod 1 rotates around its axis, the sliding mounting assembly 6 and the microphone 8 rotate accordingly, to maintain the counterweight balance during the rotation of the microphone mounting assembly 6 with the microphone 8 mounted, and prevent the microphone 8 from falling. Therefore, during the sound collection process, the connection between the mounting bracket 61 and the adjusting bracket 62 is used as the fulcrum, and the mounting requirement is to ensure the weight balance on both sides of the fulcrum. Thus, the position where the mounting bracket 61 is mounted on the adjusting bracket 62 is determined. When both sides of the fulcrum are balanced, even if the support rod 1 is rotated to drive the sliding mounting assembly 6 and the microphone 8 to rotate accordingly, the weights on both sides of the fulcrum are balanced, without any situation where one end is light and the other end is heavy. In summary, it makes the microphone 8 less likely to fall off during the directional and/or rotational adjustment of the microphone 8.

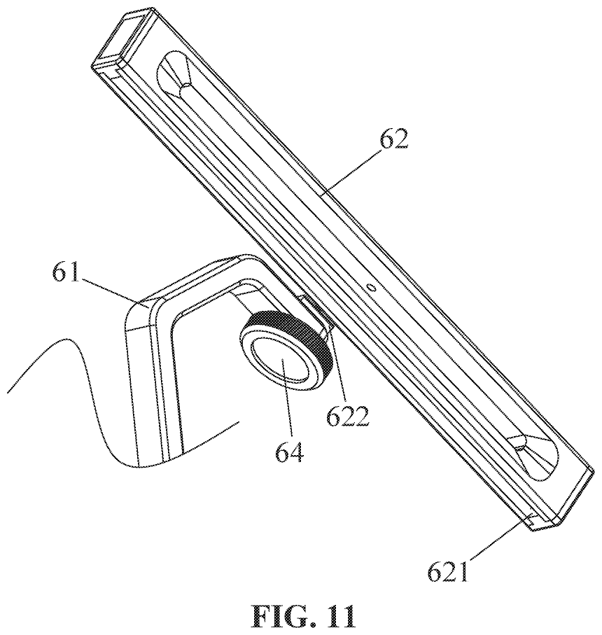

Referring to FIG. 11, in some aspects, one side of the adjusting bracket 62 is provided with a support clip 63 (see FIG. 9), and the other side is provided with a strip chute 621. A slider 622 is arranged in the chute. A screw 64 for locking the mounting bracket 61 to the chute is movably arranged at the end of the mounting bracket 61 far from the support rod 1. The screw 64 is threadedly connected with the slider 622. When the screw 64 is loosened, the mounting bracket 61 and the slider 622 are in a relaxed or released state, and the slider 622 can be moved at this time, to adjust the mounting position of the mounting bracket 61 in the strip chute 621. When it is determined that a certain position can balance the weights of the adjusting bracket 62, the supporting clip 63, and the microphone 8 on both sides of the screw 64, the screw 64 is tightened, so that the mounting bracket 61 and the slider 622 are locked, and the mounting bracket 61 is locked in the strip chute 621, thereby ensuring the mounting balance of the microphone 8.

In some aspects, the support clip 63 is fixedly provided on the adjusting bracket 62, and the mounting position is arranged on the support clip 63. In some examples, two support clips 63 can be arranged on the adjusting bracket 62, and the mounting positions are arranged on the two support clips 63.

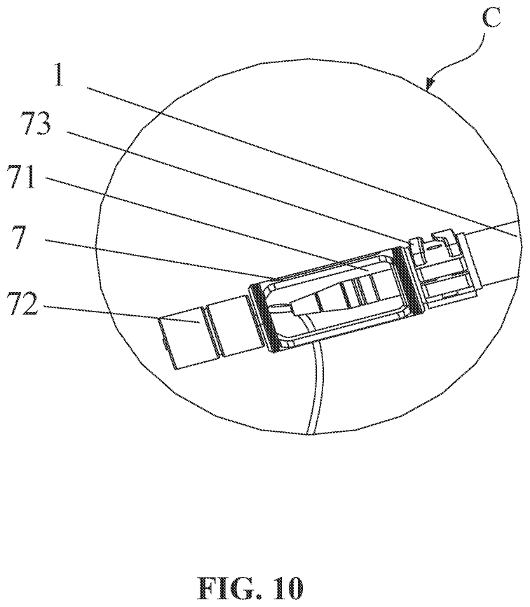

Referring to FIG. 10, one end of the support rod 1 is provided with a counterweight bracket 7 for adding counterweight. The counterweight bracket 7, the adjusting rod 21, the support component 3, and the microphone mounting assembly 6 are arranged on the support rod 1 in turn. The position settings of the above-mentioned counterweight bracket 7, the adjusting rod 21, the support component 3, and the microphone mounting assembly 6 make the setting of the center of gravity of the support rod 1 more reasonable and more convenient to use.

The counterweight bracket 7 can be provided with a cavity 71 at the interface corresponding to the other end of the support rod 1, and a counterweight weight 72 is mounted on the counterweight bracket 7.

In one embodiment, the counterweight bracket 7 is detachably arranged at the end of the support rod 1. In one example, the counterweight bracket 7 is detachably sleeved on the end of the support rod 1 through a locking ring 73.

In one embodiment, both ends of the support rod 1 are provided with interfaces, and the interfaces at both ends of the support rod pass through the inside of the support rod for providing an electrical connection. For example, the communication lines of the interfaces at both ends of the support rod 1 can be arranged inside the support rod. The interface on the end of the support rod 1 corresponding to the counterweight bracket 7 can be an audio interface for connecting an external recording device, and the interface on the end of the support rod 1 corresponding to the mounting position is an interface for connecting an external microphone 8.

In one embodiment, the support rod 1 can be a telescopic support rod 1, which comprises a plurality of sleeved rod bodies or pieces. In one example, when any two rod bodies are rotated (e.g., relative to each other), the support rod 1 can be extended or contracted.

One embodiment further provides a recording structure, wherein the recording structure comprises a microphone 8, a recording device, and a microphone stand. The microphone 8 is detachably clamped on the mounting position, and the recording device is electrically connected with the microphone 8. The recording device can be a photography device (e.g., camera) with recording function, or an existing sound recorder.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, processes, operations, elements, and/or components, but do not preclude the presence or addition of one or more other features, integers, processes, operations, elements, components, and/or groups thereof.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect electrical or other communicative coupling between two structures. Also, the term “approximately” means within ten percent of the stated value.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A microphone stand comprising:
a support rod comprising a mounting position for mounting a microphone at a first end portion of the support rod;
a support component for supporting the support rod, the support component being movably connected to the support rod; and
an adjustment system connected to a second end portion of the support rod away from the mounting position, configured to adjust a pitch angle of the support rod relative to the support component.

2. The microphone stand according to claim 1, wherein the support component comprises a support member and a support ring, the support rod is rotatably arranged in the support ring, and the support member is movably connected with the support ring.

3. The microphone stand according to claim 2, further comprising:
a first connecting piece; and
a first locking piece,
wherein the first connecting piece is sleeved on the support rod, the first locking piece is sleeved on the first connecting piece to lock the first connecting piece on the support rod, and the support ring is rotatably sleeved on the first connecting piece.

4. The microphone stand according to claim 1, further comprising:
a microphone mounting assembly provided at the first end portion of the support rod away from the adjustment system, wherein the microphone mounting assembly is configured to provide the mounting position.

5. The microphone stand according to claim 4, wherein the microphone mounting assembly comprises:
a mounting bracket; and
an adjusting bracket, wherein a first end of the mounting bracket is fixed to the support rod, and a second end of the mounting bracket is slidably connected to the adjusting bracket, and the mounting position is arranged on a side of the adjusting bracket away from the mounting bracket.

6. The microphone stand according to claim 1, further comprising:
a counterweight bracket for adding counterweight at the second end portion of the support rod away from the microphone at the first end portion of the support rod,
wherein the counterweight bracket, the adjustment system, and the support component are arranged on respective portions of the support rod in turn.

7. The microphone stand according to claim 1, wherein the adjustment system comprises:
an adjusting rod; and
a transmission mechanism,
a first end of the transmission mechanism being movably connected to the adjusting rod, and a second end of the transmission mechanism is movably connected to the support rod,
a rotation of the adjusting rod around a first axis driving via the transmission mechanism the support rod to rotate around a second axis that is different from the first axis.

8. The microphone stand according to claim 7, wherein the transmission mechanism comprises:
a transmission frame body and a transmission assembly,
the transmission frame body comprising a first connecting part and a second connecting part,
the first connecting part being connected with the second connecting part, and an angle being formed at the connection between the first connecting part and the second connecting part,
the first connecting part being rotatably sleeved on the adjusting rod, the second connecting part being rotatably sleeved on the support rod, and the adjusting rod being in transmission connection with the support rod via the transmission assembly.

9. The microphone stand according to claim 8, wherein the transmission assembly comprises a transmission rope and a plurality of pulleys,
the plurality of pulleys being movably arranged on two sides of the first connecting part or the second connecting part, respectively,
two ends of the transmission rope being sleeved on the support rod and the adjusting rod, respectively, and
two sides of a middle part of the transmission rope are sleeved on the plurality of pulleys, respectively.

10. The microphone stand according to claim 9, wherein the adjusting rod is provided with a first annular chute, and the support rod is provided with a second annular chute,
a first end of the transmission rope being sleeved in the first annular chute, and being wound multiple times in the first annular chute,
a second end of the transmission rope being sleeved in the second annular chute, and being wound multiple times in the second annular chute.

11. A recording structure comprising:
a microphone;
a recording device; and
a microphone stand according to claim 1, the microphone being arranged in a mounting position at a first end portion of the microphone stand, and the recording device being electrically connected with the microphone via the microphone stand.
